(19) United States
(12) Patent Application Publication
(10) Pub. No.: US 2025/0107538 A1
(43) Pub. Date: Apr. 3, 2025

(54) METHOD FOR COATING OR FOR PRODUCING A CONTAINER FROM AN EDIBLE OR AT LEAST BIODEGRADABLE MATERIAL

(71) Applicant: ALLCUP GMBH, Muenster (DE)

(72) Inventors: Sarah Theresa SCHULTE, Muenster (DE); Lara WAGEMANN, Muenster (DE); Martin NAUEN, Moenchengladbach (DE)

(73) Assignee: ALLCUP GMBH, Muenster (DE)

(21) Appl. No.: 18/851,613

(22) PCT Filed: Mar. 29, 2023
(86) PCT No.: PCT/EP2023/058207

§ 371 Date: Sep. 26, 2024

(30) Foreign Application Priority Data
Mar. 31, 2022 (DE) 10 2022 107 750.0
Jun. 30, 2022 (DE) 10 1022 116 324.5

(51) Int. Cl. A21D 13/28; A21D 13/24; A21D 13/33; B65D 65/46

(52) U.S. Cl. CPC A21D 13/28; A21D 13/24; A21D 13/33; B65D 65/463; B65D 65/466

(57) ABSTRACT

The invention relates to a method for coating or for producing a container from an edible or at least biodegradable material, for receiving a liquid, the surface of the container being wetted with a coating liquid, and to containers obtainable by said method, and use thereof.

### PRIORITY

This application corresponds to the U.S. National phase of International Application No. PCT/EP2023/058207, filed Mar. 29, 2023, which, in turn, claims priority to German Patent Application Nos. 10 2022 107 750.0 filed Mar. 31, 2022 and 10 2022 116 324.5 filed Jun. 30, 2022, the contents of which are incorporated by reference herein in their entirety.

### TECHNICAL FIELD OF THE INVENTION

The invention relates to a method for coating or for producing a container from an edible or at least biodegradable material for receiving a liquid, the surface of the container being wetted with a coating fluid, and to containers obtainable by said method, and use thereof.

### BACKGROUND OF THE INVENTION

Synthetic containers such as disposable cups of plastic represent a huge environmental problem. Therefore, there is a great need to provide usable disposable containers, in particular such consisting of a dough produced with flour. Such containers are described, e.g. in DE 19646752 C1. Such afore-mentioned containers are consumable for humans and animals and accordingly, are of the quality of foodstuffs.

For example, such a dough produced with flour can be produced from flour, water, optionally eggs, butter, etc. in a known manner. Waffles are particularly suitable.

The afore-mentioned containers can, for example be designed in the form of cups and bowls or in another way for receiving a liquid.

However, it should be possible to fill such containers with a liquid and even a hot liquid. In the prior art it is of disadvantage that such containers rapidly become soft and hot after filling and the liquid can leak out.

The object of the present invention is to prevent penetration of heat and moisture in such containers from a dough produced with flour.

Accordingly, a suitable heat barrier and moisture barrier are to be provided.

A further object is to configure the barrier protection such that the afore-mentioned container is consumable for humans and animals and accordingly, the quality of foodstuffs is maintained.

WO2020061653A1 describes suitable drinking containers, however there is no wetting with a suitable barrier. Wetting is advantageously by means of a coating liquid, since according to the invention impregnation can be achieved and accordingly, the container from a dough produced with flour is stable and suitable for its intended use for a prolonged period.

The problems are solved by the imparted technical teaching of at least one of the claims.

### SUMMARY OF THE INVENTION

Therefore, the invention relates to a method for coating or for producing a container from an edible or at least biodegradable material which preferably has a dough produced with flour, a natural product, such as wood or vegetable fibers, paper, and/or paper board, and is suitable for receiving a liquid, with the surface of the container being wetted with a coating fluid, wherein a fluid in the sense of the invention is understood to be any medium which is flowable or spreadable, which contains i.) coconut butter, and/or candelilla wax and ii.) alginate, and/or chicle gum.

The invention also relates to a fluid which contains i.) coconut butter, and/or candelilla wax, and ii.) alginate and/or chicle gum and is suitable to seal a container surface such that entry and/or passage for a liquid is at least complicated compared to an uncoated state of the container.

In particular, according to the invention embodiments of the coating fluid are preferred which contain i.) coconut butter as well as candelilla wax and ii.) alginate, or i.) coconut butter and ii.) alginate and chicle gum, or i.) candelilla wax and ii.) alginate.

According to the invention a container can take any form which allows food and/or beverages to be provided or to be at least received in or on the container for a time. In particular, these are cups, mugs, plates, bowls, pots, straws, and/or dishes.

In particular, coconut butter proves to be particularly suitable, since coconut butter has a natural very high content of saturated fatty acids or fats, respectively, more than other vegetable fruits and moreover is advantageously viscous. Said advantageous viscosity leads to the fact that the coating agent or coating fluid, respectively can be better processed without negatively affecting the heat resistance of the coating agent as well as the haptics and/or product quality of the containers coated with the coating agent according to the invention.

In a further preferred embodiment according to the present invention the coconut butter is hydrogenated or at least partially hydrogenated, with hydrogenation of the double bonds of the unsaturated fatty acid residues taking place with hydrogen in the presence of suitable catalysts (e.g., nickel) so that even more saturated fatty acids or fats, respectively are present.

Furthermore, the inventors have found that both alginate and chicle gum are particularly suitable to generate a heat and moisture barrier, in particular the combination of alginate and chicle gum, wherein according to the invention sodium alginate being preferably used in the coating agent or coating fluid, respectively.

According to the invention the above-mentioned components, i.e., coconut butter, candelilla wax, alginate, and/or chicle gum can be present in the coating agent or coating fluid, respectively in different amounts and in different combinations, wherein not all of these components have to be present in the coating agent or coating fluid, respectively.

If present in the coating agent or coating fluid, respectively it is preferred that coconut butter is present in the coating agent or coating fluid, respectively in an amount of 1-10 wt. %, particularly preferred of 4-8 wt. %; candelilla wax in an amount of 0.1-10 wt. %, particularly preferred of 1.5-6 wt. %; alginate in an amount of 0.5-3.0 wt. %, particularly preferred of 1.3-2.5 wt. %; and chicle gum in an amount of 0.5-6.0 wt. %, particularly preferred of 3.3-5.9 wt. %.

Unless stated otherwise all weight percentages (wt. %) mentioned are based on the total weight of the coating agent or coating fluid, respectively.

In a preferred embodiment according to the present invention the coating fluid therefore contains i.) 4-8 wt. % of coconut butter and ii.) 0.5-3 wt. % of alginate and/or 0.5-6.0 wt. % of chicle gum.

Moreover, an embodiment is preferred wherein the coating agent or coating fluid, respectively contains i.) 4-10 wt. % of coconut butter and ii.) 0.5-3.0 wt. % of alginate as well as 1.0-5.9 wt. % of chicle gum.

Also according to the invention are embodiments in which the coating agent or coating fluid, respectively contains i.) 4-10 wt. % or 5-6 wt. % of candelilla wax and ii.) 0.5-3.0 wt. % or 1.5-2.5 wt. % of alginate.

In another preferred embodiment of the invention the coating agent or coating fluid, respectively contains i) 1-6 wt. % of coconut butter as well as 0.1-1.5 wt. % of candelilla wax and ii) 0.5-3.0 wt. % of alginate. In particular, according to said embodiment a coating fluid is preferred which contains i) 2-5.5 wt. % or 3-5.0 wt. % of coconut butter and 0.2-1.0 wt. % or 0.5-0.8 wt. % of candelilla wax and ii) 0.8-2.0 wt. % or 1.0-1.5 wt. % of alginate.

In a further preferred embodiment of the invention the coating agent or coating fluid, respectively additionally contains components selected from the group consisting of glycerin, wax, candelilla wax, soy, soybean lecithin, mono and diglycerides of dietary fatty acids preferably having a melting point of 65-70° C. and advantageously being tasteless, such as e.g., mono and diglycerides produced from hydrogenated rape-seed oil (CAS No. 91052-47-0), and optionally further excipients and additives which all advantageously are consumable and advantageously contribute to the heat and moisture barrier. It is particularly preferred if the coating fluid contains mono and diglycerides of dietary fatty acids, polyoxyethylene sorbitan mono-oleate, casein, soybean lecithin, and/or glycerin. It is particularly preferred if the coating fluid additionally contains polyoxyethylene sorbitan mono-oleate, and/or casein. In this way, the viscosity of the coating agent or coating fluid, respectively can be controlled. Both substances promote the formation of an emulsion in the production method of the coating agent or coating fluid, respectively.

The amounts of the additional components used for this purpose depend on the above-mentioned main components used in the coating agent. Typically, e.g., mono and diglycerides of dietary fatty acids are used in an amount of 0.1-10.wt. %, particularly preferred of 1-6 wt. %; polyoxyethylene sorbitan mono-oleate in an amount of 0.1-4 wt. %, particularly preferred of 0.2-3 wt. %; casein in an amount of 0.1-1 wt. %, particularly preferred of 0.2-0.4 wt. %; soybean lecithin in an amount of 0.1-1 wt. %, particularly preferred of 0.1-0.4 wt. %; and/or glycerin in an amount of 0.4-3 wt. %, particularly preferred of 1.0-1.5 wt. %.

Moreover, the coating agents according to the invention contain water as a carrier for the components present in the coating agent. According to the invention it is preferred if the coating agent or coating fluid, respectively contains water in an amount of 80-90 wt. % or 83-89 wt. %.

In order to obtain the coating agent or coating fluid, respectively according to invention the above-mentioned components of the coating agent or coating fluid, respectively are mixed in a suitable vessel and homogenized. Then, the thus obtained mixture is heated under stirring, preferably under vacuum, so that an emulsion is formed which subsequently is cooled to room temperature (20-25° C.) for further use.

In addition, the invention relates to advantageous embodiments selected from a coating agent or a coating fluid which have the following compositions in wt. %, with the emphasized amounts being the preferred ones:
a.)

TABLE 1

| | | |
|---|---|---|
| 1 | water | 85-89-90 |
| 2 | coconut butter | 6.6-7.2-8 |
| 3 | candelilla wax E902 | 1.5-1.8-2 |
| 4 | sodium alginate E401 | 1.3-1.6-1.9 |
| 5 | soybean lecithin E322 | 0.1-0.4-1 |

or
b.)

TABLE 2

| | | |
|---|---|---|
| 1 | water | 80-85-90 |
| 2 | coconut butter | 4-7.6-10 |
| 3 | chicle gum | 1.0-3.3-5.9 |
| 4 | sodium alginate E401 | 0.5-1.9-3 |
| 5 | mono and diglycerides of dietary | 0.1-0.49-1 |
| | fatty acids (powder) E471 | |
| 6 | glycerin E422 | 0.4-1.46-3 |

or
c.)

TABLE 3

| | | |
|---|---|---|
| 1 | water | 80-86-90 |
| 2 | candelilla wax E902 | 5-5.6-6 |
| 3 | mono and diglycerides of dietary | 5-5.6-6 |
| | fatty acids E471 | |
| 4 | sodium alginate E401 | 1.5-2-2.5 |

Particularly preferred are coating fluids consisting of 89 wt. % of water, 7.2 wt. % of coconut butter, 1.8 wt. % of candelilla wax, 1.6 wt. % of sodium alginate, and 0.4 wt. % of soybean lecithin; or 85.25 wt. % of water, 7.6 wt. % of coconut butter, 3.3 wt. % of chicle gum, 1.9 wt. % of sodium alginate, 0.49 wt. % of mono and diglycerides of dietary fatty acids, and 1.46 wt. % of glycerin; or 86.4 wt. % of water, 5.8 wt. % of candelilla wax, 5.8 wt. % of mono and diglycerides of dietary fatty acids, and 2.0 wt. % of sodium alginate.

According to the invention the afore-mentioned components are mixed and homogenized. The coating fluid is brought to ca. 65° C. under stirring and subsequently cooled down to room temperature (25° C.). Advantageously, the coating fluid is slightly semi-liquid or viscous and is extremely well suitable for sealing pores on a dough produced with flour. Also, such a coating fluid can be applied to paper, paper board, other biodegradable materials and/or natural substances which at least partially form a container for receiving liquid foodstuff in order to impregnate the surface or at least significantly complicate the penetration of liquid into the material, respectively.

Application of the coating agent or coating fluid, respectively according to the invention to the inner surface of the container should be evenly and at least partially, preferably almost completely or completely, respectively.

In a particularly suitable embodiment for producing a coating fluid first water and alginate are homogeneously mixed. Then, candelilla wax, preferably in the form of a powder, and dietary fatty acids, in particular mono and diglycerides of dietary fatty acids are admixed. The thus obtained mass is heated to 90° C. and vigorously homogenized. The premix is heated to 100° C. and homogenized. The emulsified mass is cooled down, preferably to about 30° C. Afterwards, the thus obtained coarse paste is finely dispersed to obtain a fine smooth paste.

The paste is preferably processed at room temperature, in particular at a temperature between 22 and 25° C., wherein advantageously about 3.5 g of the paste are evenly distributed in a cup. According to a specific development drying of the so coated cup takes place for about 10 min at 55° C.

Further embodiments of the invention are a coating agent or a coating fluid having the following compositions in wt. %, with the emphasized amounts being the preferred ones:

TABLE 4

| | | |
|---|---|---|
| 1 | water | 80-83-90 |
| 2 | candelilla wax E902 | 4-5.4-10 |
| 3 | mono and diglycerides of dietary | 4-5.4-10 |
| | fatty acids E471 | |
| 4 | sodium alginate E401 | 0.5-1.9-3 |
| 5 | polyoxyethylene sorbitan mono- | 0.1-3-4 |
| | oleate E433 | |
| 6 | casein | 0.1-0.4-1 |

Particularly preferred is a composition consisting of 83.9 wt. % of water, 5.4 wt. % of candelilla wax, 5.4 wt. % of mono and diglycerides of dietary fatty acids, 1.9 wt. % of sodium alginate, 3 wt. % of polyoxyethylene sorbitan mono-oleate, and 0.4 wt. % of casein.

In order to produce a preferred coating agent or a preferred coating fluid the components given in the above-mentioned table are admixed and homogenized. The mass generated by mixing is brought to a temperature of at least about 95° C. in vacuum. In doing so, the mass is always vigorously stirred thereby forming an emulsion at the given temperature of at least almost 95° C. Afterwards the emulsion is cooled down to room temperature, preferably of at least about 24° C., so that a slightly semi-liquid mass is formed. Said mass has a dynamic viscosity at 20° C. of 11860 mPa/sec. as determined in accordance with DIN EN ISO 2555 at a number of revolutions of 15 rpm.

In a further embodiment of the present invention the coating agent or coating fluid, respectively has the following compositions in wt. % based on the total weight of the coating fluid:

TABLE 5

| | | |
|---|---|---|
| 1 | water | 80-90 |
| 2 | candelilla wax E902 | 0.1-1.5 |
| 3 | mono and diglycerides of dietary fatty acids | 4-10 |
| | (powder) E471 | |
| 4 | sodium alginate E401 | 0.5-3.0 |
| 5 | polyoxyethylene sorbitan mono-oleate E433 | 0.1-1.0 |
| 6 | casein | 0.1-1.0 |
| 7 | coconut butter | 1-6 |

In said embodiment according to the invention it is particularly preferred if the composition contains water in an amount of 85-88 wt. %, candelilla wax in an amount of 0.5-0.85 wt. %, alginate in an amount of 1.0-2.0 wt. %, polyoxyethylene sorbitan mono-oleate in an amount of 0.2-0.5 wt. %, casein in an amount of 0.2-0.5 wt. %, and coconut butter in an amount of 2.5-5.0 wt. %. Here, it is particularly preferred if the coconut butter is completely hydrogenated.

In a specific embodiment according to the invention the coating fluid has the following composition in wt. % based on the total weight of the coating fluid:

TABLE 6

| | | |
|---|---|---|
| 1 | water | 87.2 |
| 2 | candelilla wax E902 | 0.79 |
| 3 | mono and diglycerides of dietary fatty acids | 5.4 |
| | (powder) E471 | |
| 4 | sodium alginate E401 | 1.27 |
| 5 | polyoxyethylene sorbitan mono-oleate E433 | 0.32 |
| 6 | casein | 0.26 |
| 7 | coconut butter (completely hydrogenated) | 4.76 |

The components mentioned in the above-mentioned tables 5 or 6 preferably are mixed and homogenized in a suitable vessel. Homogenization is preferably carried out at a number of revolutions of 200-400 rpm. Subsequently, the mass generated by mixing is heated to a temperature of e.g. 45-55° C., preferably about 50° C., under vacuum (ca. −0.5 to −1 bar) while constantly stirring with the help of a suitable stirring system. Here, it is preferred that the stirring operation is carried out at a number of revolutions of 1000-1200 rpm. Subsequently, the mixture is further stirred at a constant temperature of preferably 45-55° C., particularly preferred about 50° C., for some minutes, e.g. 1 to 10 minutes, preferably 2 to 5 minutes, under vacuum. Subsequently, in order to obtain an emulsion of the coating agent or coating fluid, respectively the number of revolutions of the stirring system is increased at a constant temperature, i.e. ca. 45-55° C. The increased number of revolutions is preferably 10000-10300 rpm. The emulsion obtained after evacuation of the vessel is preferably cooled to about 20-25° C., particularly preferred to 23-24° C., so that a slightly semi-liquid mass is formed. Said mass has a dynamic viscosity at 20° C. of 10000 mPa/sec. as determined in accordance with DIN EN ISO 2555 at a number of revolutions of 15 rpm.

In a special production method, a waffle cup, in particular a sweet waffle cup, is produced with a suitable coating, preferably using the above-described coating agent or fluid, wherein this is wetted from the inside as even as possible with the coating fluid. According to a particularly suitable embodiment 7.5 to 8.5 g, particularly preferred 8 g of the coating fluid produced as described above are sputtered from the inside onto the surface of the cup with at least one nozzle, preferably at at least about 22° C. Preferably, the thus coated cup is dried at a temperature of at least almost 55° C., preferably in a heat gun furnace, so that the coating fluid on the surface of the cup dries too and so forms a suitable coating which at least hinders penetration of liquid. In said drying process the moisture absorbed by air sur-rounding the cup is preferably actively withdrawn, e.g. by means of a fan. Preferably, the cup is in an upright position during coating and/or drying, so that its opening faces upwards. After having completed the above-described production method the final weight of the dried coating present on the inner surface of the cup is at least about 0.024 g/cm².

Another option according to the invention is that the container to be coated is wetted with a mass of the coating agent or coating fluid, respectively preferably heated to 25 bis 35° C., particularly preferred about 30° C. Preferably, wetting is performed by means of a nozzle. Here, any type of nozzle can be used which is suitable for such a type of application, e.g. the nozzle may be a flat or conical nozzle. Wetting of the inside of the container with the coating agent or coating fluid, respectively is preferably performed at a temperature of 25-35° C., particularly preferred of 30° C., namely such that 0.01-0.5 g/cm², preferably 0.02-0.4 g/cm² of the coating agent is applied to the inside of the container. Application should be performed as even as possible and over the entire surface of the inside of the container. The thus coated container is dried at a temperature of preferably 35-45° C., particularly preferred of 40° C., preferably in a heat gun furnace, until the liquid coating agent located on the surface of the inside is dry as completely as possible. The thus obtained coating of the inside of the container prevents or at least complicates penetration of liquids into the wall of the container. Preferably, the container is in an upright position during coating and/or drying, so that its opening faces upwards. Such a type of coating is particularly suitable for a coating fluid which contains i.) 1-6 wt. % of coconut butter as well as 0.1-1.5 wt. % of candelilla wax, and ii.) 0.5-3 wt. % of alginate.

According to the invention the drying period of the above-described coating method de-pends on the nature of the container, in particular on its shape and on the material used for the container, typically the drying time is between 5 and 60 minutes, preferably between 10 and 50 minutes, particularly preferred between 15 and 40 minutes.

According to the invention it is preferred that the final weight of the dried coating on the inner surface of the container is 0.005-0.05 g/cm², preferably 0.006-0.024 g/cm².

A waffle cup as described above is particularly suitable for stocking at least partially liquid foodstuff, in particular of beverages, at least for a time due to the described surface coating in the inside which at least complicates penetration of moisture and liquid. In particular, it is suitable for receiving hot beverages, such as for example coffee with an initial temperature of at least almost 90° C. If an appropriately hot liquid is filled into the waffle cup a film is formed on the cup inner wall wherein heat resistant alginates as well as fats and waxes, according to said embodiment in the form of candelilla wax and mono and diglycerides of dietary fatty acids (E471), prevent or at least complicate passage of the liquid through the cup wall at least for a certain time. A waffle cup produced according to above-described embodiment after 15 minutes after filling with a hot liquid, in particular coffee with a temperature of at least about 90° C., becomes slightly flexible, but can still be held in the hand. The heat emanating from the coffee is not or only relatively little conducted through the cup wall. Approximately one hour after filling the hot liquid, in particular coffee with a temperature of at least about 90° C., the cup deforms slightly more, but still no liquid or coffee, respectively permeates through the cup wall. The cup only becomes slightly moist, but there is still no coffee permeating through the cup wall until complete evaporation. The cup can be best consumed within the first half hour after filling the hot liquid, in particular coffee with a temperature of at least about 90° C., due to the nature of the cup wall.

According to a specific development of the invention the obtained coating fluid is sputtered or sprayed onto the surface of the container and is dried at 40-60° C., in particular at 55° C. According to the invention drying of the coating can also be performed at 92-98° C.

Another option according to the invention is that the coating fluid is applied to the surface of the container under a pressure that is reduced over an environmental pressure of about 101325 Pa, in particular vacuum. Application can preferably be performed by sputtering or spraying.

In a further advantageous process step a water-soluble calcium salt, such as calcium chloride is added to the produced cup, so that in the presence of an aqueous liquid advantageously in-situ a biofilm (gel matrix) with the alginate present in the coating can be formed on the container surface. For that, the water-soluble calcium salt can be added to the coated container according to the invention in the form of a powder, in particular onto the bottom of the container. Here, it is preferred that the dosage of the calcium salt is 20-40 mg/100 cm², in particular 25-35 mg/100 cm². Subsequently, the calcium salt is brought into solution by the aqueous liquid filled into the container. The thus dissolved calcium salt combines with the coating agent on the inside of the container, in particular as described above with the alginate present in the coating agent. The thus formed gel matrix is irreversible stable up to ca. 120° C. and additionally prevents that the liquid present in the container can migrate into the wall of the container.

Another option according to invention is to mix the calcium salt, in particular calcium chloride, with ethanol and to apply said mixture to the previously coated and dried inside of the container. Here, the ethanol should contain a small amount of water, i.e. between 0.1 and 5%, preferred between 0.5 and 3% of water. In other words, preferably ethanol is used to dissolve the calcium salt at a concentration of 95-99.9%, particularly preferred of 97-98%.

According to the invention it is preferred that calcium salt and ethanol are used in the calcium salt/ethanol mixture in a ratio of 1:4, 1:3.5, particularly preferred of 1:3.

Application of the calcium salt/ethanol mixture is preferably performed at a temperature of 20-25° C., particularly preferred at 21-23° C., wherein the mixture of calcium salt and ethanol is preferably applied to the inside of the container by spraying. Preferably, spraying is performed by means of a nozzle. Here, any type of nozzle can be used which is suitable for such a type of application, e.g. the nozzle can be a flat or conical nozzle. By spraying the calcium salt/ethanol mixture is nebulized and the ethanol contained in the mixture can evaporate at room temperature, preferably at a temperature of 20-25° C., within ca. 2-5 minutes, preferably 3-4 minutes. For that, additionally heating the container is not necessary. It should be noted that the higher the water content in the calcium salt/ethanol mixture the longer evaporation of the ethanol lasts. The calcium chloride remaining on the inside of the container in turn forms a gel matrix with the alginate present in the coating in the presence of the water present in the calcium salt/ethanol mixture.

With this type of application of the calcium salt to the inside of the container it is preferred that the coated container is coated with a coating fluid which contains i.) 1-6 wt. % of coconut butter as well as 0.1-1.5 wt. % candelilla wax and ii.) 0.5-3 wt. % alginate. In addition, it is preferred that the mixture of ethanol and calcium salt contains ethanol in an amount of 0.01-0.5 wt. %, particularly preferred of 0.05-0.25 wt. %, in particular preferred of 0.1-0.2 wt. %, and the calcium salt in an amount of 0.01-0.08 wt. %, particularly preferred of 0.02-0.05 wt. %, based on the total weight of the coating agent including calcium salt and ethanol.

By the components that according to invention are contained in the coating agent or coating fluid, respectively, in particular by combining them in the amounts given above, a coating agent or coating fluid, respectively can be provided which is water-resistant, temperature-resistant, and scratch-resistant (in the dried state) and has the desired sensory functions. Here, all components in the coating agent according to the invention are suitable for consumption.

Migration of the liquid (water) into the wall of the coated container according to the invention is particularly prevented by the alginate contained in the coating fluid which additionally has a high heat tolerance as well as the contained fats and waxes, such as candelilla wax, (hydrogenated) coconut butter, and/or mono and diglycerides of dietary fatty acids which are inherently hydrophobic. Moreover, the mono and diglycerides of dietary fatty acids used in the coating agent according to the invention have a relatively high melting point of 65 bis 70° C. and thus, like alginate, a good heat resistance. The same applies to candelilla wax.

Depending on the nature of the coated container, e.g. whether the container has hygroscopic properties due to its material, and the effects of the liquid to be filled in, e.g. temperature or mechanical effects, the coating according to the invention protects the container from the fact that liquid, in particular water, migrates into its wall for about 20 minutes up to days, preferably up to 8 days. By the liquid (water) migrating into the wall of the container it becomes softer and more flexible. However, by using the coating according to the invention complete leakage of the liquid from the container is prevented.

The coated container according to the invention can receive liquids having a temperature of preferably 5 up to 98° C., or 20-95° C., 35-90° C., 40-85° C., in particular of 45-65° C. when filled into the container. It is also possible to add (aqueous) liquids or emulsions, respectively in the frozen state, i.e. liquids/emulsions having a temperature of −20° C. to 0° C. or −10° C. to −5° C., e.g. ice cream, into the coated container according to the invention without liquid leaking out of the container during subsequent slow heating of the liquid/emulsion in the container to room temperature.

Furthermore, the invention relates to a container from an edible or at least biodegradable material, which preferably has a dough produced with flour, a natural product, such as wood or vegetable fibers, paper, and/or paper board, for receiving a liquid or foodstuff obtainable in accordance with the method according to the invention, in particular having an impregnation comprising or consisting of i.) coconut butter, and/or candelilla wax, and ii.) alginate, and/or chicle gum. The impregnation is obtained by the described spraying of a coating fluid according to the invention onto the container surface.

Moreover, the invention relates to the use of a container produced according to the invention from an edible or at least biodegradable material which preferably has a dough produced with flour, a natural product, such as wood or vegetable fibers, paper, and/or paper board, for receiving a liquid as foodstuff.

### BRIEF DESCRIPTION OF THE FIGURES

FIG. 1 depicts various views of an uncoated fiber bowl made of compostable sugar cane fiber of the present invention. Part a) presents a plan view, part b) a bottom view and part c) a side view.

### DETAILED DESCRIPTION OF THE PREFERRED EMBODIMENTS

Preferred embodiments of the invention are:

1. A method for coating a container made from an edible or at least biodegradable material, which preferably has a dough produced with flour, a natural product, such as wood or vegetable fibers, paper, and/or paper board, with the container being suitable for receiving a liquid, characterized in that the surface of the container is wetted with a coating fluid, wherein the coating fluid contains i.) coconut butter, and/or candelilla wax, and ii.) alginate, and/or chicle gum.

2. The method according to point 1, characterized in that as the material a dough at least partially produced with flour, a natural product, wood or vegetable fibers, paper, and/or paper board is provided.

3. The method for coating a container according to point 1, wherein the coconut butter is hydrogenated.

4. The method for coating a container according to point 1 or 2, wherein the coating fluid has at least one further component selected from the group of glycerin, wax, candelilla wax, soy, soybean lecithin, mono and diglycerides of dietary fatty acids, and optionally further excipients and additives.

5. The method for coating a container according to any of the preceding points, wherein the coating fluid has i.) 4-8 wt. % of coconut butter, and ii.) 0.5-3 wt. % of alginate, and/or 0.5-6.0 wt. % of chicle gum.

6. The method for coating a container according to any of the preceding points, wherein the coating fluid has i.) 5-6 wt. % of candelilla wax, and ii.) 1.5-2.5 wt. % of alginate.

7. The method for coating a container according to any of the preceding points, wherein the coating fluid has the following compositions in wt. %:
a.)

| | | |
|---|---|---|
| 1 | water | 85-89-90 |
| 2 | coconut butter | 6.6-7.2-8 |
| 3 | candelilla wax E902 | 1.5-1.8-2 |
| 4 | sodium alginate E401 | 1.3-1.6-1.9 |
| 5 | soybean lecithin E322 | 0.1-0.4-1 |

or b.)

| | | |
|---|---|---|
| 1 | water | 80-85-90 |
| 2 | coconut butter | 4-7.6-10 |
| 3 | chicle gum | 1.0-3.3-5.9 |
| 4 | sodium alginate E401 | 0.5-1.9-3 |
| 5 | mono and diglycerides of dietary | 0.1-0.49-1 |
| | fatty acids (powder) E471 | |
| 6 | glycerin E422 | 0.4-1.46-3 |

or c.)

| | | |
|---|---|---|
| 1 | water | 80-86-90 |
| 2 | candelilla wax E902 | 5-5.6-6 |
| 3 | mono and diglycerides of dietary | 5-5.6-6 |
| | fatty acids E471 | |
| 4 | sodium alginate E401 | 1.5-2-2.5 |

or d.)

| | | |
|---|---|---|
| 1 | water | 80-83-90 |
| 2 | candelilla wax E902 | 4-5.4-10 |
| 3 | mono and diglycerides of dietary | 4-5.4-10 |
| | fatty acids E471 | |
| 4 | sodium alginate E401 | 0.5-1.9-3 |
| 5 | polyoxyethylene sorbitan mono- | 0.1-3-4 |
| | oleate E433 | |
| 6 | casein | 0.1-0.4-1 |

8. The method for coating a container according to any of the preceding points, wherein the coating fluid is sputtered onto the surface of the container and is dried at 40-60° C., in particular at 55° C.

9. The method for coating a container according to any of points 1 to 7, wherein the coating fluid is sputtered onto the surface of the container and is dried at 92-98° C., in particular at 95° C.

10. The method for coating a container according to any of the preceding points, wherein the coating fluid is applied, in particular sputtered or sprayed, to the surface of the container under a pressure which is reduced compared to an environmental pressure of about 101325 Pa, in particular in vacuum.

11. The method for coating a container according to any of the preceding points, wherein a water-soluble calcium salt, in particular calcium chloride, is added to the cup produced.

12. A method for producing a container in which a method for coating a container according to at least one of the preceding points is employed.

13. A coating agent for coating containers suitable for receiving a liquid, wherein the coating agent contains i.) coconut butter, and/or candelilla wax, and ii.) alginate, and/or iii.) polyoxyethylene sorbitan mono-oleate (E433) and casein, and/or chicle gum.

14. The coating agent according to point 13, wherein the coconut butter is at least partially hydrogenated.

15. The coating agent according to point 13 or 14, wherein the coating agent has at least one further component selected from the group of glycerin, wax, candelilla wax, soy, soybean lecithin, mono and diglycerides of dietary fatty acids, and optionally further excipients and additives.

16. The coating agent according to any of points 13 to 15, wherein the coating agent has i.) 4-8 wt. % of coconut butter, and ii.) 0.5-3 wt. % of alginate, and/or iii.) polyoxyethylene sorbitan mono-oleate (E433) and casein, and/or 0.5-6.0 wt. % of chicle gum.

17. The coating agent according to any of points 13 to 15, wherein the coating agent has i.) 5-6 wt. % of candelilla wax, and ii.) 1.5-2.5 wt. % of alginate.

18. The coating agent according to any of the preceding points, wherein the coating agent has the following compositions in wt. %:
a.)

| | | |
|---|---|---|
| 1 | water | 85-89-90 |
| 2 | coconut butter | 6.6-7.2-8 |
| 3 | candelilla wax E902 | 1.5-1.8-2 |
| 4 | sodium alginate E401 | 1.3-1.6-1.9 |
| 5 | soybean lecithin E322 | 0.1-0.4-1 |

or b.)

| | | |
|---|---|---|
| 1 | water | 80-85-90 |
| 2 | coconut butter | 4-7.6-10 |
| 3 | chicle gum | 1.0-3.3-5.9 |
| 4 | sodium alginate E401 | 0.5-1.9-3 |
| 5 | mono and diglycerides of dietary | 0.1-0.49-1 |
| | fatty acids (powder) E471 | |
| 6 | glycerin E422 | 0.4-1.46-3 |

or c.)

| | | |
|---|---|---|
| 1 | water | 80-86-90 |
| 2 | candelilla wax 902 | 5-5.6-6 |
| 3 | mono and diglycerides of dietary | 5-5.6-6 |
| | fatty acids E471 | |
| 4 | sodium alginate E401 | 1.5-2-2.5 |

or d.)

| | | |
|---|---|---|
| 1 | water | 80-83-90 |
| 2 | candelilla wax E902 | 4-5.4-10 |
| 3 | mono and diglycerides of dietary | 4-5.4-10 |
| | fatty acids E471 | |
| 4 | sodium alginate E401 | 0.5-1.9-3 |
| 5 | polyoxyethylene sorbitan mono- | 0.1-3-4 |
| | oleate E433 | |
| 6 | casein | 0.1-0.4-1 |

19. A container for receiving a liquid which at least in some areas is coated with a coating agent according to any of points 13 to 18.

20. A container made from a dough produced with flour for receiving a liquid obtainable in accordance with a method according to any of points 1 to 12 having an impregnation comprising i.) coconut butter, and/or candelilla wax, and ii.) alginate, and/or iii.) polyoxyethylene sorbitan mono-oleate (E433) and casein, and/or chicle gum.

21. Use of a container made from a dough produced with flour for receiving a liquid according to point 18 as foodstuff.

### EXAMPLES

The following examples are for the detailed explanation of the invention, however without to limit the invention to said examples.

### Example 1

A sweet waffle cup is wetted with the coating fluid according to the invention from the inside in the splash method. Here, the mass (25°-40° C.) is sputtered in a splash manner from below into the upturned waffle cup (opening downwards). Excessive mass drips out of the cup. In a heat gun furnace (ca. 50°-55° C.) the liquid coating dries on the cup surface. Here, the cup stands upright (opening upwards). Moisture in the air is actively withdrawn after the cup and the coating have firmly bonded. The final weight of the dried coating per cm²=0.015 g according to composition a.) and 0.024 g according to composition b.). Compositions a.) and b.) correspond to the preferred embodiments of the compositions according to tables 1 and 2.

According to a specific further development of said embodiment it is conceivable to spread calcium chloride on the bottom of the cup as soon as the cup and the coating have firmly bonded.

### Example 2

Now, hot coffee (90° C.) can be filled into the cup of example 1. If calcium chloride is present on the bottom of the cup this is dissolved in the coffee and reacts with the sodium alginate and a film is formed in-situ at the inner wall of the cup.

In any case, the candelilla wax components hydrogenate under 60° C. coffee temperature and seal the cup from the inside. After 15 minutes the cup softens, but can be hold in the hand. The heat of the coffee penetrates the cup wall in a damped manner. After one hour the cup deforms. Coffee still does not penetrate the cup. The cup becomes slightly moist, but does not loose coffee through the cup wall until complete evaporation. The cup can best be consumed within the first half hour.

### Example 3

### Materials

components of the coating agent:

TABLE 7

| | | | Amount |
|---|---|---|---|
| | | Amounts | Ratios |
| No. | Raw Material | [g] | [wt. %] |
| 1 | water (20° C.) | 696.88 | 87.11 |
| 2 | candelilla wax E902 | 6.32 | 0.79 |
| 3 | mono and diglycerides of | 43.20 | 5.4 |
| | dietary fatty acids (powder) | | |
| | E471 | | |
| 4 | sodium alginate E401 | 9.60 | 1.2 |
| 5 | polyoxyethylene sorbitan | 2.56 | 0.32 |
| | mono-oleate E433 | | |
| 6 | casein | 2.08 | 0.26 |
| 7 | coconut butter (completely | 38.08 | 4.76 |
| | hydrogenated) | | |
| 8 | ethanol 97% | 0.96 | 0.12 |
| 9 | calcium chloride E509 | 0.32 | 0.04 |

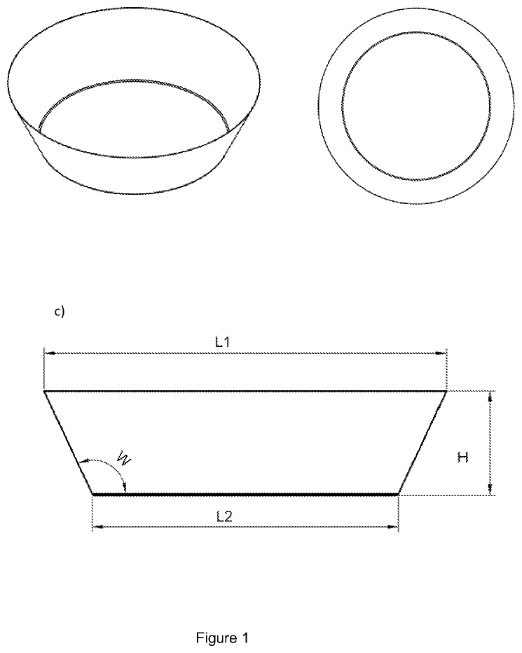

uncoated fiber bowl made of compostable sugar cane fiber with a volume of 800 mL (see FIG. 1; a) plan view, b) bottom c) side view (L1=184.88 mm; L2=140.67 mm; H=47.97 mm; A=115.11°)); area of the inside including bottom: ca. 422 cm²
heatable (at least 80° C.) and exhaustable 2.5 L stainless steel container; shaving blade insert; rotational speed: >10200 rpm
vacuum pump (pumping capacity: 85 L/hr)
slot nozzle for highly viscous liquids (Sprayingsystems GmbH, liquid nozzle 2850 S.S.CO./air cap 62240-60-SS-S.S.CO.)
heatable spraying system with jacket heating and heatable spraying head
convector with active moisture withdrawal (Palux Kombidampfer Basic 623 SL)

### Production of the Coating Fluid:

The components 1-7 given in table 7 were mixed in the above-mentioned stainless-steel container and homogenized at a number of revolutions of 350 rpm. Subsequently, a vacuum was generated in the container by means of a vacuum pump (ca. −0.8 bar). An overrun in the component mixture was prevented by deaerating the mixing chamber, so that the obtained mixture consisting of components 1 to 7 had a density of ca. 0.99 g/mL.

The mixture was heated to 50° C. under continuous stirring (number of revolutions ca. 1100 rpm) and subsequently further stirred at a constant temperature (50° C.) with a number of revolutions of 1100 rpm for ca. 2 to 3 minutes. Subsequently, the number of revolutions was increased to 10200 rpm, with the temperature further being held at 50° C. to obtain an emulsion of components 1 to 7. Afterwards, the stainless-steel container was aerated and the obtained emulsion was cooled to ca. 24° C. The emulsion, i.e. the coating fluid, was slightly semi-liquid and had a viscosity of ca. 10000 mPa/sec. (20° C.), as determined in accordance with DIN EN ISO 2555 at a number of revolutions of 15 rpm.

### Coating of the Fiber Bowl:

The amount of the coating fluid needed for coating was pre-tempered under vacuum to ca. 30° C. in the above-described stainless-steel container at a number of revolutions of 1100 rpm.

Coating of the fiber bowl was performed by means of the heatable spraying system onto which the slot nozzle was mounted. The liquid pressure for conveying the tempered coating fluid in the spraying system and for spraying the coating fluid was 1 to 1.5 bar at an atomizing air of 0.8 to 1.2 bar. The distance of the nozzle to the bottom of the fiber bowl during coating was ca. 15 cm.

The nozzle sprayed the coating fluid in a flat jet with an angle of 80 to 90°, so that the inside of the fiber bowl including the bottom was uniformly and almost completely wetted with the coating fluid. For the coating an amount of the coating fluid of ca. 23 to 26 g was used and the coating was applied with a layer thickness of ca. 0.05 g/cm².

The fiber bowl wetted with the liquid coating fluid was subsequently dried in a heat gun furnace at 40° C. For that, the highest possible convection at 0% humidity in the gas space was used. The drying period was ca. 40 to 50 minutes. The final weight of the dried coating per cm² of the inside of the fiber bowl was ca. 0.007 to 0.0065 g/cm².

Subsequently, the calcium chloride mixed with ethanol (see components No. 8 and 9 of table 7) was applied to the coated inside of the fiber bowl at room temperature (ca. 23° C.). For application, the calcium chloride/ethanol mixture was slightly nebulized by means of the spraying system, so that the ethanol which is volatile at room temperature could evaporate within 3 to 5 minutes.

### Result:

Water with a temperature of ca. 40° C. was filled into the coated fiber bowl. Even after ca. 20 minutes penetration of the water into the wall of the fiber bowl could not be observed. Leakage of the water could not be observed even after days, the fiber bowl only became softer and more flexible with time.

1. A method for coating a container made from an edible or at least biodegradable material, with the container being suitable for receiving a liquid, characterized in that the surface of the container is wetted with a coating fluid, wherein the coating fluid contains i.) coconut butter, and/or candelilla wax, and ii.) alginate, and/or chicle gum.

2. The method according to claim 1, characterized in that as the material a dough at least partially produced with flour, a natural product, wood or vegetable fibers, paper, and/or paper board is provided.

3. The method for coating a container according to claim 1, wherein the coating fluid has at least one further component selected from the group of glycerin, wax, candelilla wax, soy, soybean lecithin, mono and diglycerides of dietary fatty acids, and optionally further excipients and additives.

4. The method for coating a container according to claim 1, wherein the coating fluid has;
(a)i.) 4-8 wt. % of coconut butter, and ii.) 0.5-3 wt. % of alginate, and/or 0.5-6.0 wt. % of chicle gum; or
(b)i.) 5-6 wt. % of candelilla wax, and ii.) 1.5-2.5 wt. % of alginate; or
(c)i.) 1-8 wt. % of coconut butter as well as 0.1-2.0 wt. % of candelilla wax, and ii.) 0.5-3.0 wt. % of alginate.

5. The method for coating a container according to claim 1, wherein the coating fluid is sputtered onto the surface of the container and is dried at 40-60° C., in particular at 55° C.; or at 92-98° C., in particular at 95° C.

6. The method for coating a container according to claim 5, wherein a water-soluble calcium salt, in particular calcium chloride, is added to the coated container; or a mixture of calcium salt, in particular calcium chloride, is applied to the inside of the coated container.

7. The method for coating a container according to claim 6, wherein the coating fluid has i.) 1-6 wt. % of coconut butter as well as 0.1-1.5 wt. % of candelilla wax, and ii.) 0.5-3.0 wt. % of alginate, based on the total weight of the coating fluid; and after having applied the coating fluid to the surface of the inside of the container and the subsequent drying of the coated container a mixture of calcium salt, in particular calcium chloride, and ethanol is applied to the coated inside of the container.

8. The method for coating a container according to claim 7, wherein the coating fluid is heated to 25-35° C. before it is applied to the inside of the container and is dried at 35-45° C. after it has been applied to the inside of the container.

9. The method for coating a container according to claim 7, wherein the mixture of calcium salt and ethanol is applied to the inside of the container by spraying.

10. A method for producing a container in which a method for coating a container according to at least one of the preceding claims is employed.

11. (canceled)

12. (canceled)

13. (canceled)

14. A container made from a dough produced with flour for receiving a liquid obtainable in accordance with a method according to claim 1 having an impregnation comprising i.) coconut butter, and/or candelilla wax, and ii.) alginate, and/or iii.) polyoxyethylene sorbitan mono-oleate (E433) and casein, and/or chicle gum.

15. Use of a container made from a dough produced with flour for receiving a liquid according to claim 14 as foodstuff.
